(19) United States
(12) Patent Application Publication
(10) Pub. No.: US 2018/0220823 A1
(43) Pub. Date: Aug. 9, 2018

(54) Magnetic Retention Device for Tumbler Carrying Tray

(71) Applicant: Joshua T. Lawhon, Midwest City, OK (US)

(72) Inventor: Joshua T. Lawhon, Midwest City, OK (US)

(21) Appl. No.: 15/428,882

(22) Filed: Feb. 9, 2017

(51) Int. Cl. A47G 23/06; A47G 23/02; A47G 23/03; A47J 47/00; A47C 7/54; A47G 19/08; A47B 13/16; A47C 7/68

(52) U.S. Cl. CPC A47G 23/0641; A47G 23/0208; A47G 23/03; A47J 47/005; A47G 2023/0666; A47G 19/08; A47B 13/16; A47C 7/68; A47C 7/54

(57) ABSTRACT

A retention device for a vessel has a bottom portion affixed to a serving vessel with a first magnet contained therein, and a holder having a recess formed into a top surface and having a second magnet at a bottom of the recess, wherein the recess is formed in a size, shape and depth for receiving and releasably retaining the bottom portion through mutual attracting of the first and second magnets. In optional embodiments, the bottom portion may comprise a coaster, and the vessel may comprise a beverage tumbler. In other embodiments, the vessel may include a beverage glass, a mug, a stein, a plate, a cup or a bowl, and the holder's magnetic recesses may be formed in a tray, a table, a bar, a counter top, a shelf, a platter, a chair arm, or a cutting board.

### FIELD OF THE INVENTION

The invention generally relates to trays, platters, and serving surfaces for transporting tumblers, glasses, mugs, steins, plates, cups and bowls.

### BACKGROUND OF INVENTION

“Beer flights” are particularly popular ways for restaurants and bars to offer patrons a way to sample or taste a number of different beers. Most beer flights are served as a set of filled glasses or tumblers, each containing a different flavor or type of beer, arranged in a row on a serving “paddle” or tray. The tumblers are filled at the bar or kitchen, placed on the tray or paddle, and then carried by hand to the table or bar where the patron is located.

### SUMMARY OF EXEMPLARY EMBODIMENTS OF THE INVENTION

Disclosed is a retention device for a vessel which has a bottom portion affixed to a serving vessel with a first magnet contained therein, and a holder having a recess formed into a top surface and having a second magnet at a bottom of the recess, wherein the recess is formed in a size, shape and depth for receiving and releasably retaining the bottom portion through mutual attracting of the first and second magnets. In optional embodiments, the bottom portion may comprise a coaster, and the vessel may comprise a beverage tumbler. In other embodiments, the vessel may include a beverage glass, a mug, a stein, a plate, a cup or a bowl, and the holder's magnetic recesses may be formed in a tray, a table, a bar, a counter top, a shelf, a platter, a chair arm, or a cutting board.

### BRIEF DESCRIPTION OF THE DRAWINGS

The description set forth herein is illustrated by the several drawings.

FIG. 1 illustrates three views of the retention device in three modes of usage.

FIG. 2 shows a serving flight “paddle” with four of the retention devices in use for carrying and transport.

### DETAILED DESCRIPTION OF EXEMPLARY EMBODIMENT(S) OF THE INVENTION

The present inventor has realized that the transport of multiple filled serving vessels, such as a flight of beer glasses, presents a particular need that is unmet in the restaurant and bar serving wares market as of today. There are many beer flight sets available, many of which provide a single row of seats for glasses to be placed down into the tray or even through the tray, but if the server does not keep the tray level as he or she walks and weaves through a crowded restaurant or bar, the glasses may tip over and spill.

Whether the glasses are relatively cylindrical in shape, or even more top heavy such as wine glasses and snifter glasses, this problem remains. And, even if the glasses are relatively smaller, such as a row of shot glasses for tastings of liquors such as tequila, the problem still remains—there is a requirement for the server to maintain the tray at a very level position while transporting it.

This problem can be further compounded by serving situations in which the consumption room is not stable, such as in a galley or deck of a boat or ship, onboard an airplane, or on a train. If the server is jostled by movement of the floor on which he or she is traveling, keeping the tray level is even more difficult.

For these various reasons, the present inventor has recognized a need in the art for a serving tray and vessel arrangement which provides a retention device keep one or more vessels on the tray with a certain amount of retention force to retain the vessels on the tray with a tilt of the tray of up to 20 degrees from level. Further, it is desirable for the retention device to be quick to engage, preferably without the server having to watch it visually to promote quick loading of the tray. Still further, it is desirable for the retention device to be easily disengaged, and for the retention device to be relatively unobtrusive on the appearance of the vessels so as to avoid interfering with the appearance or “presentation” of the food or beverages served therein.

While the specific exemplary embodiment disclosed in the following paragraphs will relate to a flight of beer glasses, it will be readily recognized by those skilled in the art that it may be equally well embodied for other forms of vessels, such as tumblers, glasses, mugs, steins, plates, cups and bowls. And, similarly, while the following exemplary embodiment will be set forth relative to a “paddle” style of serving tray, it will be readily recognized by those skilled in the art that it may be equally well embodied in other serving trays, tables, preparation surfaces and serving surfaces.

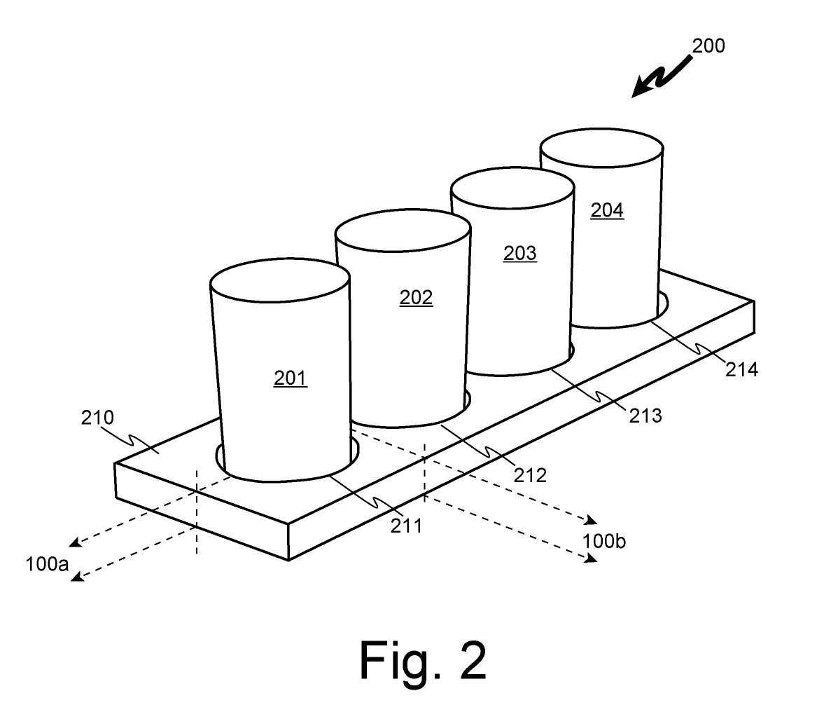

Referring now to FIG. 2, an arrangement (200) of a tray and one or more serving vessels is shown in a configuration suitable for serving a flight of beer samplers. The tray (210) contains a plurality of recessed seats (211, 212, 213, 214) for receiving a plurality of glasses or tumblers (201, 202, 203, 204). The retention devices according to the present invention are not visible in this configuration, thereby avoiding changing the visual presentation of a normal beer flight. Please note sectional lines 100a and 100b in FIG. 2.

In this mode, the filled tumblers (201, 202, 203, 204) may be transported by a wait person, and as the tray is tilted or jostled from side to side, the portions of the tumblers below the top surface of the tray and down within the recesses prevents the tumblers from sliding side-to-side (laterally), and the invisible retention device(s) keep the bottoms of the tumblers in contact with the bottoms of the recesses, thereby preventing the tumblers from lifting up and bouncing on the tray or even hopping off the tray.

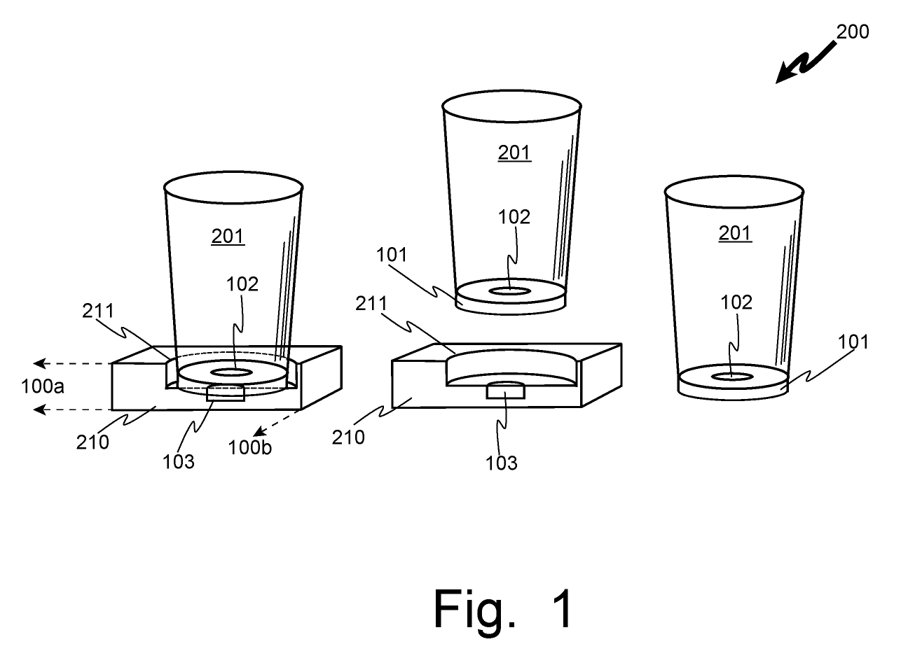

Referring now to FIG. 1, a portion of the tray is shown in a cut-away view along sectional lines 100a and 100b. In the left-most view, a carrying mode is shown with a bottom portion (101) of the tumbler (201) received into a tray recess (211), and retained by mutually attracting magnets (102, 103). Preferably, the bottom portion (211) is no thicker (taller) than the depth of the tray recess (211), such that the rest of the tumbler is presented above the top surface of the tray (210) as if it were sitting on top of or slightly below the surface of the tray.

In the center view of FIG. 1, the tumbler (201) is shown lifted out and above the recess (103) by using enough upward force on the tumbler to overcome the weight of the glass and its contents plus the attraction force of the magnets (103, 102). The bottom portion (101) is preferably permanently affixed to the bottom surface of a glass or other vessel, such that lifting the glass or vessel also lifts the bottom portion.

In the third (rightmost) view of FIG. 1, the third mode of the bottom portion (101) is shown in which it serves as a coaster for the tumbler (201), preferably providing protection from condensation on the outer surface of the tumbler reaching a table top, providing thermal insulation between the bottom of the tumbler and the table top, and providing reducing lateral slipping of the tumbler on the table top.

In at least one embodiment, the bottom portion is constructed of a material such as wood, plastic, resin, aluminum, medium density fiberboard (MDF), cardboard, cork or stone. In at least one embodiment, the tray is constructed of wood, plastic, resin, aluminum, medium density fiberboard (MDF), cardboard, cork or stone.

In at least one embodiment, the vessels comprise tumblers, mugs, steins, wine glasses, snifter glasses, cups, bowls and plates. In at least one embodiment, both the vessel and the tray recesses are provided with magnets in attracting orientations, and in at least one embodiment, only one of the vessel or tray is provided with magnets and the other is provided with a metal portion (slug, disk, etc.) which is attracted to magnets.

In a preferred embodiment, the strength of the attraction of the magnets is chosen relative to the weight of the vessel, its contents (e.g., volume), and the weight of the tray. If the magnets severely overpower the combined weights of the tray, vessel and contents, then the consumer may have to place one hand on the tray and use the other hand to lift upwards to break the magnetic pull. Such an overpowering magnetic force not only would be inconvenient by requiring two-handed operation, but it may also lead to the consumer sloshing and spilling the contents of the vessel right after the magnetic connection (circuit) is broken.

However, if the magnetic attractive force is too weak, the heavier filled vessels may overcome the magnetic force when the tray is tipped or jostled, thereby allowing the vessels to slip out of the recesses or hop (bounce) in the recesses, causing spillage.

For these reasons, at least in one embodiment, the strength of the attractive forces between the two magnets, when measured at the distance between them in the carrying mode (leftmost view of FIG. 1) is preferably selected to be between one-quarter to one-half the weight of the vessel and its expected contents, and/or between one-quarter to one-half the weight of the tray with no vessels on it.

For example, consider a beer flight arrangement with 4 mini tasting glasses, in which each glass weighs 4 oz. (including the bottom portion with magnet), and has a capacity of 5 fluid oz. of beer (about 5.3 oz. in weight at 1.0625 pounds per pint of beer). And, consider that the empty tray (with magnets) weighs 20 ounces (1.25 pounds) when constructed of a certain type of material (wood, plastic, etc.). In this particular embodiment, the full glasses weigh 37.2 oz., but the tray weighs only 20 ounces. So, the maximum magnet break-away attractive force when the last glass is being raised from the tray, with all the other glasses empty or removed, should be between 5 and 10 ounces (¼ to ½ of the weight of the empty tray). In other embodiments for varying vessels and contents, the magnet strengths may be adjusted or selected appropriately, of course.

While the exemplary embodiment shown in FIG. 2 is of a beer flight paddle, those ordinarily skilled in the art will readily recognize that other shapes of trays and patterns of recesses fall within the spirit and scope of the invention, as to other types of serving and preparation surfaces, such as tables, bars, shelves, platters, chair arms, and cutting boards.

The foregoing exemplary embodiment(s) is/are intended to teach how to make and use the invention, but not to express the limits of the spirit and scope of the invention. In some embodiments, a disclosed singular element may be replaced by a plurality of elements, and vice versa, without departing from the spirit and scope of the invention. Alternative materials from those disclosed in the exemplary embodiments may be employed, so long as the function and intended performance is maintained or improved.

1. A retention device for a plurality of serving vessels comprising:
a plurality of bottom portions, each affixed to one of a plurality of serving vessels; and
a holder having a plurality of recesses formed into a top surface;
wherein each of the plurality of recesses is formed in a size, shape and depth for receiving and releasably retaining a serving vessel bottom portion, and wherein the recesses and bottom portions are provided with a magnetically attractive pair of components, each pair of components having a magnetic pull force not exceeding one half of a weight of the holder, thereby allowing a vessel to be removed from the holder without requiring a user hand or additional mechanism to hold the tray down during separation of a vessel from the holder.

2. The retention device as set forth in claim 1 wherein the bottom portion comprises a coaster.

3. The retention device as set forth in claim 1 wherein the vessel comprises a beverage tumbler.

4. The retention device as set forth in claim 1 wherein the vessel comprises at least one vessel selected from the group consisting of a beverage glass, a mug, a stein, a plate, a cup and a bowl.

5. The retention device as set forth in claim 1 wherein holder comprises a paddle-shaped tray.

6. The retention device as set forth in claim 1 wherein the pull force is greater than or equal to one-quarter of the weight of the holder.

7. The retention device as set forth in claim 1 wherein the pair of components is selected from the group consisting of a pair of magnets, and a magnet paired with a metal portion.

8. The retention device as set forth in claim 1 wherein the holder comprises a serving or preparation surface selected from the group consisting of a table, a bar, a counter top, a shelf, a platter, a chair arm, and a cutting board.

9. A method for manufacturing a retention device for a vessel comprising:
affixing a plurality of bottom portions, each affixed to one of a plurality of serving vessels; and
providing a holder having a plurality of recesses formed into a top surface;
wherein each of the plurality of recesses is formed in a size, shape and depth for receiving and releasably retaining a serving vessel bottom portion, and wherein the recesses and bottom portions are provided with a magnetically attractive pair of components, each pair of components having a magnetic pull force not exceeding one half of a weight of the holder, thereby allowing a vessel to be removed from the holder without requiring a user hand or additional mechanism to hold the tray down during separation of a vessel from the holder.

10. The method as set forth in claim 9 wherein the bottom portion comprises a coaster.

11. The method as set forth in claim 9 wherein the vessel comprises a beverage tumbler.

12. The method as set forth in claim 9 wherein the vessel comprises at least one vessel selected from the group consisting of a beverage glass, a mug, a stein, a plate, a cup and a bowl.

13. The method as set forth in claim 9 wherein holder comprises a paddle-shaped tray.

14. The method as set forth in claim 9 wherein the pull force is greater than or equal to one-quarter of the weight of the holder.

15. The method as set forth in claim 9 wherein the pair of components is selected from the group consisting of a pair of magnets, and a magnet paired with a metal portion.

16. The method as set forth in claim 9 wherein the holder comprises a serving or preparation surface selected from the group consisting of a table, a bar, a counter top, a shelf, a platter, a chair arm, and a cutting board.
